(19) United States
(12) Patent Application Publication
(10) Pub. No.: US 2004/0244037 A1
(43) Pub. Date: Dec. 2, 2004

(54) Information browsing method, transmitting apparatus and receiving apparatus

(76) Inventors: Takao Yamaguchi, Machida-shi (JP); Tomoaki Itoh, Kawasaki-shi (JP); Junichi Sato, Nara-shi (JP); Ichiro Takei, Suginami-ku (JP)

Correspondence Address: RATNERPRESTIA, P O BOX 980, VALLEY FORGE, PA, 19482-0980, US

(21) Appl. No.: 10/493,883

(22) PCT Filed: Feb. 26, 2003
(86) PCT No.: PCT/JP03/02134

(51) Int. Cl. H04N 5/445; G06F 3/00; G09G 5/00; G06F 13/00

(52) U.S. Cl. 725/37; 725/52; 345/723

(57) ABSTRACT

In a broadcast using packet transmission, zapping-data and program data are packet-transmitted from a transmitting apparatus. A receiving apparatus receives and stores the data and zapping-data. Until the program data selected upon program reproduction becomes reproducible, zapping-data is reproduced, whereby the viewer can know the information about a program without waiting for a lapse of reproduction wait time after switching a program channel.

### TECHNICAL FIELD

The present invention relates to an information browsing method, transmitting apparatus and receiving apparatus for realizing a high-speed zapping process in a network with packet transmission.

### BACKGROUND ART

Conventionally, because the television broadcast on terrestrial wave uses a broad band, the signals over a plurality of channels simultaneously reach the receiving apparatus. Consequently, when switching the receiving program, browsing is possible at high speed for the programs on the air (hereinafter referred to as “zapping”). However, in the case of realizing a broadcast system using an IP network (system that data is sent from a transmitting terminal unit onto a plurality of channels while a receiving terminal unit selects a channel to reproduce video images, audio sound, texts or still images), zapping is difficult to carry out. For example, in the IP network with packet transmission, when video image or sound is sent in streaming, because there is a need for a buffering time to absorb the fluctuations in propagation delay over the usual transmission passage, a delay is necessarily caused in an amount for buffering time from switching a receiving program up to commencing video reproduction. Also, in the case of synchronously displaying moving image, sound, a still image and a text, a wait time occurs that is to receive a still image, text data, layout information determining a layout of these of data, and synchronous information. Furthermore, in the case a plurality of programs are sequentially distributed one by one from the nearest relay node, a wait time necessarily occurs before commencing program distribution.

No proposal has been made on the information browsing method, transmitting apparatus and receiving apparatus for solving this. There has been merely something like the descriptions, for example, of JP-A-11-196385 and JP-A-5-207387 as means for the viewer to select a viewing program on a broadcast or communication network. FIG. 16 shows a block diagram of a conventional broadcast system described in JP-A-11-196385.

In FIG. 16, a broadcast station 1601 carries out multiplex on the main program-information to broadcast a digest including the contents of tag information and body information from a broadcast line 1604. The digest and the main program-information to be introduced therein are saved to a database 1606 of a program provider 1602. A receiving terminal unit 1603 has scheduling means 1607 for receiving an EPG digest having as a content the tag information of the digests and plotting a reception schedule for the digests, display means 1608, and communication means 1610 for communicating with the database 1606 through a communication line 1605. The viewer at a desired time projects and browses, on the display means 1608, the contents of the digests gathered in the receiving terminal unit 1603, to obtain a main program on the basis of a digest from the database.

Herein, the broadcast station 1601 has a transmitting means 1611, a information generating means 1612, a multiplexing means 1613 and a scrambler 1614. The program provider 1602 has the database 1606, a search means 1615 and a communication means. The receiving terminal unit 1603 has the scheduling means 1607, a receiving means, a demultiplexing means, routing means 1618, a descramble means 1619, a display means 1608, a cache & directory control means 1620, a access control means 1621, a charge means 1622, the storing means 1609, a filtering means 1623, a favor storing means 1624, a human i/f means, search means 1625, a input means and the communication means 1610.

Meanwhile, FIG. 17 shows a block diagram of a conventional receiving apparatus described in JP-A-5-207387. In FIG. 17, there are provided a selecting section 1701 for selecting and receiving a television signal channel by channel, and an accumulating storing section 1703 for storing television video information demodulated through a demodulating section 1702 and multiplexed information (program-information). Also, provided are program-information extracting means 1704 for extracting multiplexed information (program-information) out of received demodulated signals and information holding means 1705 for holding extracted program-information.

Furthermore, there are provided a storing section 1706 for storing the program-information having been held in the information holding means 1705, start-up means 1708 having a reserve button 1707 to designate a program reservation, control means 1709 for transferring the program-information within the information holding means 1705 and storing it to the storing section 1706 when a reservation is designated by the start-up means 1708, a time counter 1710 playing a role of a timepiece, and start-up control means 1712 for switching the selecting section 1701 to a television station of a channel number shown by the program-information and staring up a power source section 1711 when the count value of the time counter 1710 reaches a start time of the program-information stored in the storing section 1706.

Herein, a transmitting station 1713 provides some program preview and program information 1714a-1714n. A display section 1715 displays a program preview video.

However, because the conventional configuration of JP-A-11-196385 is a method to take the program data selected from the accumulated digests out of a database of an information provider or the like, it is impossible to view a program currently on the air when browsing the digests.

Also, because the conventional configuration of JP-A-5-207387 is a method to make a program reservation by browsing through accumulated program preview video images, it is impossible to carry out zapping over the programs currently on the air.

The broadcast using a network with packet transmission, by using such a conventional art, has had a problem that there is difficulty in zapping at high speed the programs being broadcast in synchronism with the moving image, sound, still image and text.

### DISCLOSURE OF THE INVENTION

It is an object of the present invention to provide an information browsing method, transmitting apparatus and receiving apparatus for realizing high-speed zapping reduced in waiting time from channel switching up to reproduction in a program-broadcast using a network for packet transmission.

A method of browsing information of the present invention, in a broadcast using packet transmission, comprises: a step of receiving program data and zapping-data as data for realizing zapping; a step of storing the zapping-data; and a step of reproducing the zapping-data until program data selected upon program reproduction becomes reproducible.

Due to this, the viewer can know information about a program without waiting for a lapse of reproduction wait time after switching a program channel.

Also, in the information browsing method of the invention, the zapping-data is at least any one of a part of a program including layout information, a digest, a representative screen, a program title (text), a preview, an announcement and an advertisement.

Due to this, the viewer can know an outline of a program to be desirably viewed without waiting for a lapse of reproduction wait time after switching a program channel.

Also, in the information browsing method of the invention, information of the zapping-data is multiplexed based on a media kind or information configuring a screen.

Due to this, by sending a plurality of pieces of information with multiplexing, a plurality of kinds of information can be sent in one packet, making possible to greatly reduce the header.

Also, the information browsing method of the invention, further comprises a step of generating the zapping-data from the program data received.

Due to this, for a program not prepared with zapping-data for the program, the receiving apparatus can previously store zapping-data. The viewer even when switching to this program can know an immediately-preceding video image or the like without waiting for a lapse of reproduction wait time.

A transmitting apparatus according to the present invention, in a broadcast using packet transmission, comprises: a program-broadcast managing section for controlling a start and end of a program-broadcast; a data managing section for storing data to be sent; a zapping-data selecting section for generating or selecting zapping-data from the data stored in the data managing section, on the basis of an instruction from the program-broadcast managing section; a forward control section for forwarding, on a predetermined rule, program data from the data managing section and the zapping-data from the zapping-data selecting section; and a transmitting section for receiving data from the forward control section and packet-transmitting the zapping-data and the program data.

Due to this, zapping-data is sent together with program data. Accordingly, in the case of transmitting a plurality of programs in the same timing, any of zapping-data and program data can be sent equally for all the programs.

Also, the transmitting apparatus of the invention further comprises a zapping-data generating rule section for determining a multiplexing scheme of zapping-data, and zapping-data multiplexing section for multiplexing zapping-data by a multiplexing scheme determined in the zapping-data generating rule section.

Due to this, by sending a plurality of pieces of information with multiplexing, a plurality of kinds of information can be sent in one packet, making possible to greatly reduce the header.

Also, the multiplexing scheme in the transmitting apparatus of the invention is for multiplexing based on a program in a case that the number of programs to be simultaneously sent is within a predetermined number and for multiplexing based on any of a media kind and information configuring a screen in a case of equal to or greater than the predetermined number.

Due to this, provided that the number of programs is within such a number as the delay between programs is not problematic, all the zapping-data is collectively sent based on a program, making possible to send zapping-data efficiently to the receiving apparatus. On the other hand, even if the number of programs exceeds a predetermined number, all the programs are evenly sent based on a media. The zapping-data of any program, concerning a part of medias, can be received in a brief time by the receiving apparatus. Display or the like is possible preferentially for the media received earlier.

Also, in the transmitting apparatus of the invention, zapping-data is sent before starting a program-broadcast as a subject of the zapping.

Due to this, transmission amount is taken into account in the transmission timing of zapping-data, thereby enabling forwarding in the timing less in transmission amount.

A receiving apparatus according to the invention, in a broadcast using packet transmission, comprises: a transmitting section for receiving packet-transmitted zapping-data and program data; a reception control section for discriminating a kind of information received by the transmitting section; a zapping-data storing section for storing the zapping-data discriminated; a program selecting section for instructing to receive the program data a viewer has selected; a reproduction control section for reproducing zapping-data concerning the program data taken out of the zapping-data storing section until the reception data received due to the instruction by the transmitting section becomes reproducible; and a zapping-data restoring section for selecting and taking out the zapping-data instructed for taking out from the reproduction control section.

Due to this, the viewer can know information about a program without waiting for a lapse of reproduction wait time after switching a program channel.

Also, the receiving apparatus of the invention further comprises a zapping-data generating section for generating the zapping-data from received program data.

Due to this, it is possible to use, while selecting, suited one of the zapping-data received from the transmitting apparatus and the zapping-data generated from the program data. Accordingly, even if the viewer commences zapping in any timing, it is possible to display or so, at all times, an outline of a program being currently on the air or immediate-preceding broadcast screen in the shortest time.

Also, a receiving apparatus according to the invention, in a broadcast using packet transmission, comprises: a transmitting section for receiving program data; a zapping-data generating section for generating zapping-data from the program data received; a zapping-data storing section for storing the zapping-data; a program selecting section for instructing to receive the program data a viewer has selected; a reproduction control section for reproducing zapping-data concerning the program data taken out of the zapping-data storing section until the reception data received due to the instruction by the transmitting section becomes reproducible; and a zapping-data restoring section for selecting and taking out the zapping-data instructed for taking out from the reproduction control section.

Due to this, the receiving apparatus can previously store the zapping-data generated from the program data. Accordingly, the viewer at any time can know the immediately-preceding video image or the like without waiting for a lapse of reproduction wait time after switching a program channel.

As described above, according to the present invention, in a program-broadcast using an IP network for packet transmission, high-speed zapping can be realized which is reduced in wait time from channel switching up to reproduction.

### BRIEF DESCRIPTION OF THE DRAWINGS

FIG. 1 is a block diagram showing an information browsing apparatus for realizing high-speed zapping in embodiment 1 of the present invention.

FIG. 2 is a figure showing a screen configuration example in embodiment 1 of the invention.

FIG. 3 is a flowchart showing the operation of a zapping-data generating rule section in embodiment 1 of the invention.

FIG. 4A is a flowchart showing a multiplexing method of the scheme 1 in embodiment 1 of the invention.

FIG. 4B is a flowchart showing a multiplexing method of the scheme 2 in embodiment 1 of the invention.

FIG. 5A is a figure showing a format for multiplexing of the scheme 1 in embodiment 1 of the invention.

FIG. 5B is a figure showing a format for multiplexing of the scheme 2 in embodiment 1 of the invention.

FIG. 6A is a figure showing a transmission sequence of packets of the scheme A in embodiment 1 of the invention.

FIG. 6B is a figure showing a transmission sequence of packets of the scheme B in embodiment 1 of the invention.

FIG. 6C is a figure showing a transmission sequence of zapping-data of the scheme C in embodiment 1 of the invention.

FIG. 6D is a figure showing a transmission sequence of zapping-data of the scheme D in embodiment 1 of the invention.

FIG. 7 is a flowchart showing the operation of a receiving apparatus in embodiment 1 of the invention.

FIGS. 8A and 8B are configuration diagrams showing a utilization form of a communication network in embodiment 1 of the invention.

FIG. 9 is a figure showing a program-information format in embodiment 1 of the invention.

FIGS. 10A and 10B are figures showing a reproducing method in embodiment 1 of the invention.

FIG. 11 is a flowchart showing a program reproducing process in embodiment 1 of the invention.

FIG. 12 shows a block diagram of an information browsing system in embodiment 2 of the invention.

FIG. 13 is a flowchart showing the operation of a receiving apparatus in embodiment 2 of the invention.

FIG. 14 shows a block diagram of an information browsing system in embodiment 3 of the invention.

FIG. 15 is a flowchart showing the operation of a receiving apparatus in embodiment 3 of the invention.

FIG. 16 shows a block diagram of a conventional broadcast system.

FIG. 17 shows a block diagram of a conventional receiving apparatus.

### BEST MODE FOR CARRYING OUT THE INVENTION

Hereunder, embodiments of the present invention will be explained together with the drawings. Note that, in the below explanation, program data is the information configuring a screen in a program-broadcast, including the layout information and control data for controlling display position and display timing in addition to various medias required for the program, such as moving images, sound (including music), texts, still images, animations and CGs. The describing method of layout information can use SMIL (Synchronized Multimedia Integration Language) or an object-oriented programming language, for example.

Meanwhile, zapping-data may be a part of program data to be broadcast or a screen or scene cut different from the program data and especially prepared to introduce a program. The example of zapping-data, if a part of program data, may be configured only by layout information, texts and still images. Also, it may include a program title or program representative screen of video data, or the newest I frame or voice data in several seconds of the data currently on the air. However, zapping-data requires an extremely less amount of data as compared to the program data.

Meanwhile, the program-information is information representative of what program-broadcast is to be made in what channel, e.g. describing a program title, a multicast address, a port number, a session identifier, a payload type, a TOS (Type Of Service) and so on, which is to be acquired through a predefined channel common throughout the country. Herein, the predefined channel is a set of particular IP address and port number in the case of passively receiving the data sent from a transmission terminal unit, or a particular URL in the case of passive acquisition on an HTTP from a transmission terminal by a receiving terminal unit.

First Exemplary Embodiment

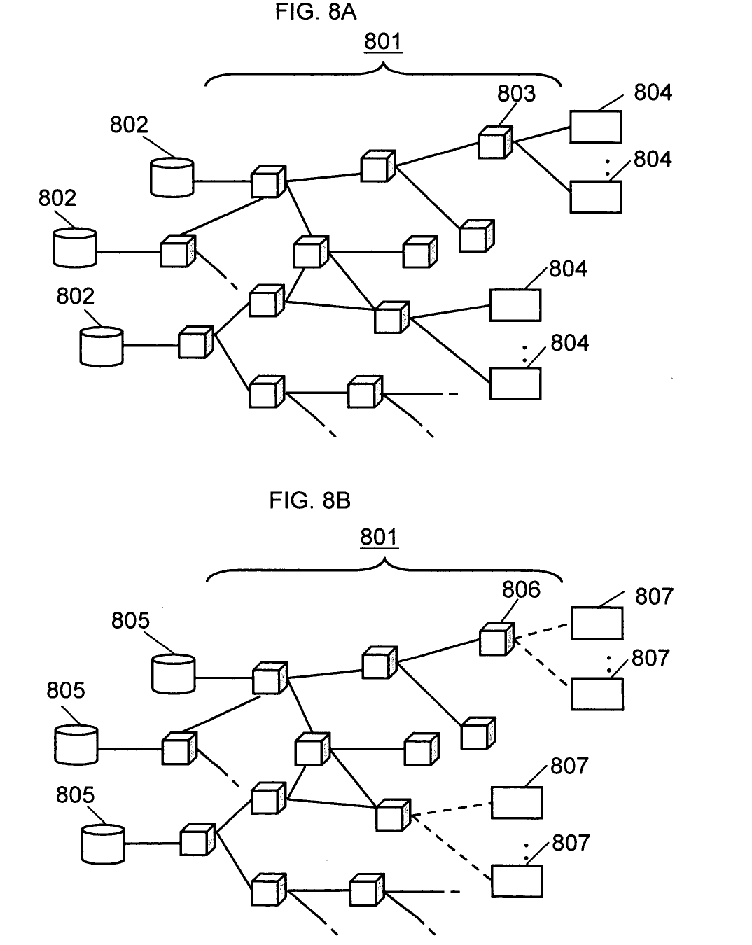

FIGS. 8A and 8B are configuration diagrams showing a utilization form of a communication network in embodiment 1 of the invention.

In FIG. 8A, a communication network 801 as an object of the invention may be a wired network (e.g. an ADSL, an ISDN, an ATM or an FTTH) or a wireless network (e.g. a cellular pone or a wireless LAN). Meanwhile, as shown in FIG. 8B, it may be a communication network having wired and wireless networks connected one with another.

The transmission protocol uses an Internet protocol while the communication apparatuses are mutually connected by relay nodes 803 such as routers and GWs (gateways). The router and GW have a broadcast or multicast function so that a data packet can be duplicated at the router or GW. Also, the content transmission method may carry out one-to-one type communication between the server 802 and the reception terminal unit 804, or one-to-N type communication with using a broadcast or multicast function. In this embodiment, multicast is to be done from the server 802 to the relay node 803 while broadcast is to be done from the relay node 803 to the receiving terminal unit. This allows the receiving terminal unit 804 to receive a newest content by opening a predetermined channel.

The transmission contents are for various medias including moving image, sound, music, text, still image and layout information.

Although zapping-data, as data for realizing zapping, is at least any one of a part of a program including layout information, a digest, a representative screen, a program title (text), a preview, an announcement, music and an advertisement. However, there is no need for limitation to a program content. There is no especial limitation provided that can effectively utilize a wait time before the program data is made reproducible. Also, in the case that zapping-data is a part of a program, a digest or a representative screen, the zapping-data to be sent, desirably, has one packet including at least one I frame. Due to this, screen display is made possible provided that having received zapping-data even by one packet.

The reception terminal units 804 may be reception terminal units that are different in display resolution or process capability, e.g. cellular phones, TV sets, PDAs or personal computers.

Meanwhile, the distribution server 802 exists in plurality. The reception terminal unit 804 may simultaneously receive contents from the plurality of servers 802. Furthermore, the reception terminal unit 804 can possess a function of access to a plurality of transmissions.

Furthermore, besides the communication network 801, the system configuration may be conjugated with a broadcast network (e.g. terrestrial-wave digital broadcast, satellite digital broadcast) or broadcast and communication networks. Particularly, in the case that a content is to be broadcast to a moving reception terminal unit as the cellular phone, there is a demand for broadcasting different contents based on each region. In such a case, in the case of carrying out broadcast or multicast from the server over to a plurality of reception terminal units, it is not easy to change the broadcast content depending upon a location. In order to realize a broadcast depending upon a location, the example of FIG. 8B carries out communication with a one-to-one unicast between the server 805 an d the relay node 806 (wired network section) and distribution, utilizing a broadcast function using a wireless network, between the relay node 806 and the reception terminal unit 807. There is no possibility for the relay node 806, for realizing a broadcast function, to broadcast a packet beyond another relay node 806.

In the network of the above embodiment, program-information and program data (moving images, sound, music, texts, still images and layout information such as SMIL, for example, for combining and displaying these) are sent from the server 802 as a transmission terminal unit. The reception terminal unit 804 receives first the program-information and then the program data on the basis of that program-information.

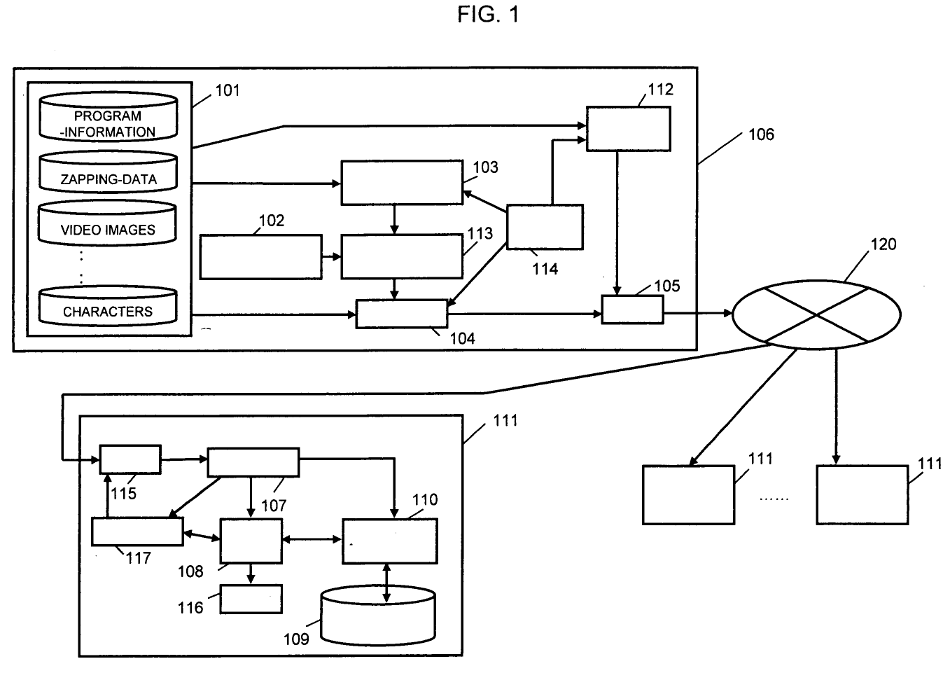

Next, FIG. 1 is a block diagram of an information browser system to realize high-speed zapping in embodiment 1 of the invention.

In FIG. 1, a transmitting apparatus 106 is the transmitting terminal unit 802 in FIGS. 8A and 8B, which sends program-information, program data and zapping-data to a plurality of receiving apparatuses 111 through an IP network 120. The transmission protocol may use a protocol for reception confirmation (e.g. TCP) or a protocol not for reception confirmation (e.g. UDP). Besides these, transmission may be by the use of a media transmission protocol represented by RTP (Realtime Transport Protocol). In such a case, a payload header may be applied which is suited for each media.

The reception apparatus 111 is the reception terminal unit 804 in FIGS. 8A and 8B, which receives program-information from a predefined channel and extracts a program currently on the air from the program-information. Then, the channel described in the program-information is opened, to receive zapping-data and program data, so that zapping-data is stored or reproduced according to an instruction of a viewer.

The IP network 120 is the communication network or broadcast network in FIGS. 8A and 8B, wherein data is to be packet-transmitted.

Hereunder, the information browser system of the invention will be concretely explained.

The transmitting apparatus 106 has a data managing section 101, a program-broadcast managing section 114, a zapping-data generating rule section 102, a zapping-data selecting section 103, a zapping-data multiplexing section 113, a forward control section 104, a program-information generating section 112 and a transmitting section 105.

The data managing section 101 is to store program data, zapping-data and program-information. The data managing section 101 is a recording medium represented by the hard disk drive.

The program-broadcast managing section 114 is to manage the broadcast start/end of the program. The program-broadcast managing section 114, at a broadcast start time of a program, instructs the zapping-data selecting section 103, the forward control section 104 and the program-information generating section 112 to start broadcasting the program. Also, at an end time, it instructs the zapping-data selecting section 103, the forward control section 104 and the program-information generating section 112 to end the broadcast of the program.

The zapping-data generating rule section 102 is means for determining a method of multiplexing zapping-data when sending zapping-data by multiplexing on the same IP packet. The determined multiplexing method is notified to the zapping-data multiplexing section 113.

The zapping-data selecting section 103 takes out the zapping-data stored in the data managing section 101 according to a program transmission start instruction from the program-broadcast managing section 114, and delivers it to the zapping-data multiplexing section 113. Otherwise, it takes out, as zapping-data, a part of the program data stored in the data managing section 101 and delivers it to the zapping-data multiplexing section 113 (in this case, there is no need to separately prepare zapping-data in the data managing section 103). Also, the zapping-data selecting section 103 suspends the delivery of the zapping-data of an instructed program to the zapping-data multiplexing section 113, according to a program ending instruction from the program-broadcast managing section 114.

The zapping-data multiplexing section 113 multiplexes the zapping-data delivered from the zapping-data selecting section 103 on the basis of the rule determined by the zapping-data generating rule section 102, and delivers it to the forward control section 104. Concerning a concrete multiplexing scheme, description will be made later. Note that, because the multiplexing process must not be carried out, the zapping-data multiplexing section 113 and zapping-data generating rule section 102 may be omitted.

The forward control section 104 reads the program data of an instructed program out of the data managing section 101 according to a broadcast start instruction from the program-broadcast managing section 114, and delivers zapping-data and program data to the transmitting section 105 by a predetermined rule referred later. Meanwhile, the forward control section 104 suspends the broadcast of an instructed program, on the basis of a broadcast end instruction from the program-broadcast managing section 114.

The program-information generating section 112 reads the program-information of an instructed program out of the data managing section 101 according to a broadcast start instruction from the program-broadcast managing section 114, and adds, if required, the program-information with the broadcast channel (destination IP address, port number and the like for each media) information of program data and zapping-data. The program-information is delivered to the transmitting section 105 with a constant period. Also, according to a broadcast end instruction from the program-broadcast managing section 114, ended is the delivery of the program-information of the instructed program to the transmitting section 105. Incidentally, in the case that program-information has previously been delivered to the receiving apparatus 111 and there is no need to transmit program-information at the time of program-broadcast, there is no necessity to provide this program-information generating section 112 to the transmitting apparatus 106.

The transmitting section 105 is an interface capable of sending data to the IP network 120. Also, the transmitting section 105 has a function to make into a packet the program-information, zapping-data and program data received from the program-information generating section 112 and forward control section 104. Furthermore, it has functions to transmit program-information to a predetermined program-information channel, and to transmit program data and zapping-data to a predefined channel on the basis of the program-information.

Incidentally, in the above system, zapping-data and program-information may be generated in real time or generated in advance of broadcast. Meanwhile, the program-information may be sent by another means without the necessity of transmission together with zapping-data and broadcast data. For example, another server for sending program-information may be prepared so that the reception terminal unit can acquire from the server by the use of an HTTP or the like.

Next, the receiving apparatus 111 will be explained below.

The receiving apparatus 111 has a reception control section 107, a program selecting section 117, a zapping-data restoring section 110, a zapping-data storing section 109, a reproduction control section 108, a display section 116 and a transmitting section 115.

The reception control section 107 discriminates a kind of the data received by the transmitting section 115, and carries out the following three processes depending upon the data kind.

1) In the case the received data is program-information, the data is delivered to the program selecting section 110.

2) In the case the received data is zapping-data, it is delivered to the zapping-data restoring section 117.

3) In the case the received data is program data, the data is delivered to the reproduction control section 108.

The program selecting section 117 selects a program to be received from the program-information received from the reception control section 107, and instructs the transmitting section 115 to receive it. Selecting a program to be received includes both of an instruction from a viewer and an instruction to receive all the programs on the air from the program-information received. The program selecting section 117 delivers the program-information to the reproduction control section 108, and causes the display section 116 to display a list of program titles or the like. Then, a viewer selects an arbitrary program from the program list displayed. Also, this program selecting section 117 seeks, from the program-information, a channel for receiving the zapping-data and program data of a program currently on the air. Incidentally, although this embodiment is contrived to send program-information from the transmitting apparatus 106 for sending program data, program-information can be obtained by another method. For example, there is a method for acquisition from an HTTP server by using an HTTP.

The zapping-data restoring section 110 has a function to receive the zapping-data from the reception control section 107, and, in the case the zapping-data is multiplexed, to store it by demultiplexing (releasing from the multiplexing) to the zapping-data storing section 109. Also, the zapping-data restoring section 110 has a function to take out of the zapping-data storing section 109 on the basis of a zapping-data acquiring request from the reproduction control section 108 and to deliver the zapping-data to the reproduction control section 108.

The zapping-data storing section 109 is to store zapping-data. Concretely, it is a storage medium represented by the hard disk drive.

The reproduction control section 108 carries out a reproduction process of the zapping-data or program data received from the zapping-data restoring section 110 and extraction of a program list from the program-information received from the program selecting section 117. The reproduction control section 108, in the case the utilizer is carrying out zapping, configures a digest or title screen of a selected program by the use of, mainly, zapping-data or program-information. In the case of browsing the program, program data and program-information are used to reproduce the program currently on the air. Incidentally, in video and audio reproduction, various schemes of decode processes are carried out for decode process. This scheme may use a standardized scheme such as MPEG4 or MPEG2, or use a non-standardized scheme. Also, the reproduction control section 108 determines a display position and display timing of a text or animation, in order to synthesize decoded information. The synchronization between medias may use a standardized scheme such as MPEG2 or SMIL, or use a non-standardized scheme.

The transmitting section 115 is an interface capable of receiving a data packet from the IP network 120. The transmitting section 115 has a function to open a program-information receiving channel and receive program-information, and to open a channel instructed for starting reception from the program selecting section 117 and receive zapping-data and program data. Also, it has a function to take data out of received various data packets and deliver it to the reception control section 107. Furthermore, the transmitting section 115 has a function to close the channel instructed for ending reception from the program selecting section 117 and to suspend the reception of zapping-data and program data.

Incidentally, in this embodiment, although program-information, zapping-data and program data are to be transmitted through the same transmission passage, these may be received at separate transmission passages in the case that the receiving apparatus 111 has a function of access to a plurality of transmission passages.

The display section 116 is to present various medias, such as AV data, a text and a still image, decoded by the reproduction control section 108 to the viewer in the timing determined by the reproduction control section 108. The presentation to the viewer is, concretely, by the use of a video display device represented by CRT or LCD and a sound reproducing device such as a speaker.

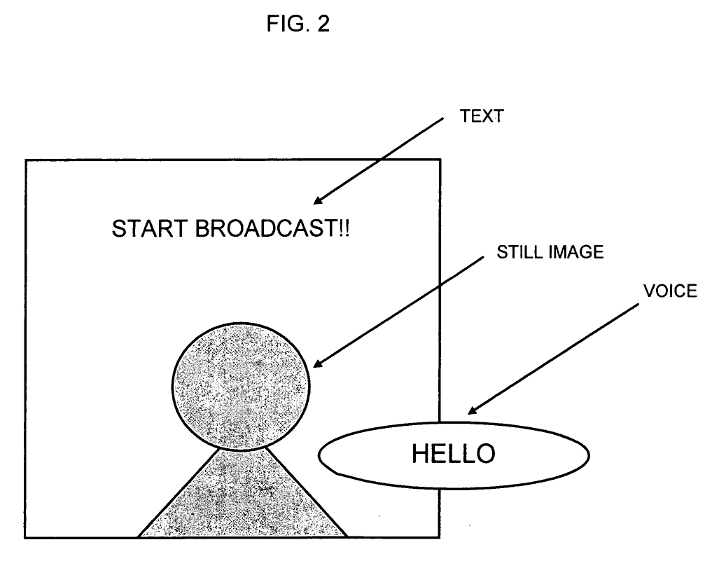

FIG. 2 is a configuration figure of a screen to be presented by the display section 116 to the viewer.

The screen example is configured with one screen by a still image, a text and voice. The synchronization and display timing between the medias are described and expressed by the SMIL or an object-oriented programming language.

The transmitting apparatus 106 and receiving apparatus 111 configured as in the above will be explained below in its operation and function.

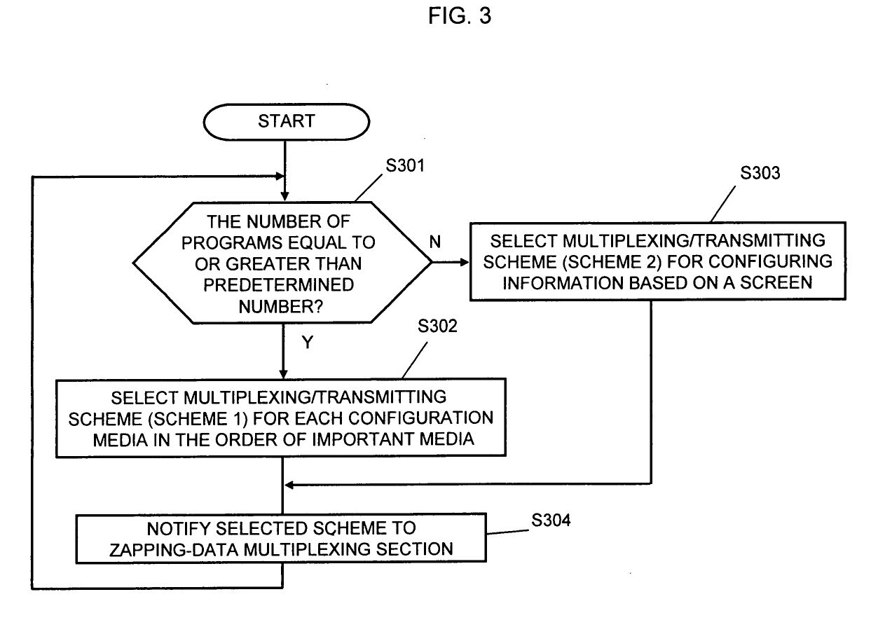

FIG. 3 is a flowchart explaining the operation of the zapping-data generating rule section 102 that is a constituent element of the transmitting apparatus 106. Incidentally, in this embodiment, the zapping-data of a plurality of medias is multiplexed together and sent by one packet. By thus transmitting a plurality of pieces of information through multiplexing, because a plurality of kinds of information can be sent by one packet, the headers can be greatly reduced. In the case where header overhead is not problematic, the multiplexing process can be omitted.

The packet header and data multiplexing method can use, for example, an RTP (Realtime Transfer Protocol) standardized in IETF. Also, the kind of a multiplexed media can be expressed by a description in a payload type.

First, the zapping-data generating rule section 102, when sending the zapping-data of a plurality of programs by multiplexing, determines whether the number of programs exceeds a predetermined number at which there is no problem with a delay between programs (step S301). In the case of an excess, selected is a scheme to multiplex and send the information in the order of important media for configuring a screen (hereinafter, referred to as “scheme 1”) (step S302). In this embodiment, determination has been made in the order of higher importance of SMIL (information for determining a layout, the receiving apparatus cannot correctly process program data unless this information exists), text, moving image (intra-frame importance set high while inter-frame importance set low), still image and sound. Otherwise, multiplexing may be preferentially for the information to be desirably notified to the viewer (e.g. title, notice, etc.).

Next, the selected scheme is notified to the zapping-data multiplexing section 113 (step 304).

On the other hand, in the case that the number of programs does not exceed a predetermined number, selected is a scheme to multiplex constituent pieces of information based on the screen (hereinafter, referred to as “scheme 2”) (step 303). Thereafter, step S304 is executed.

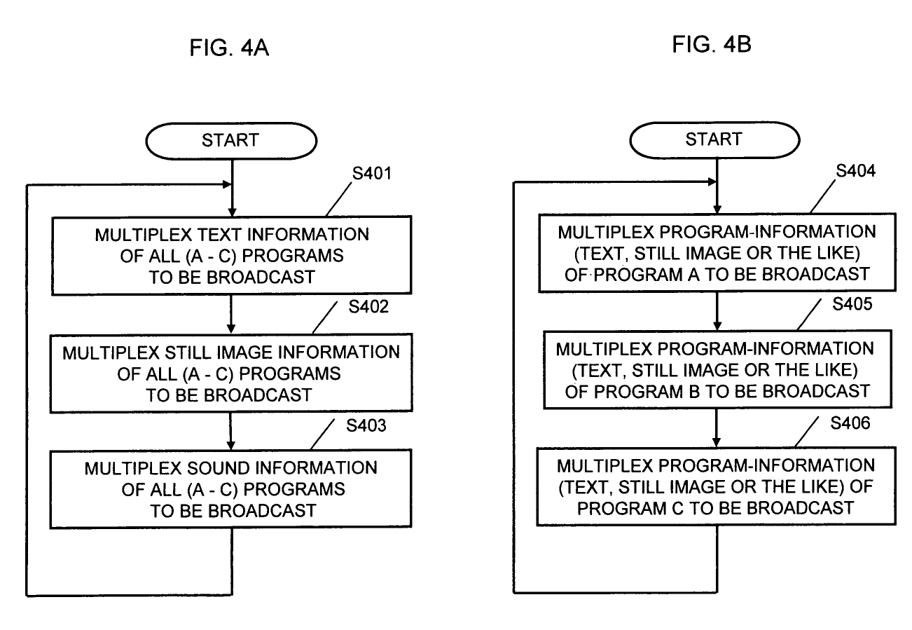

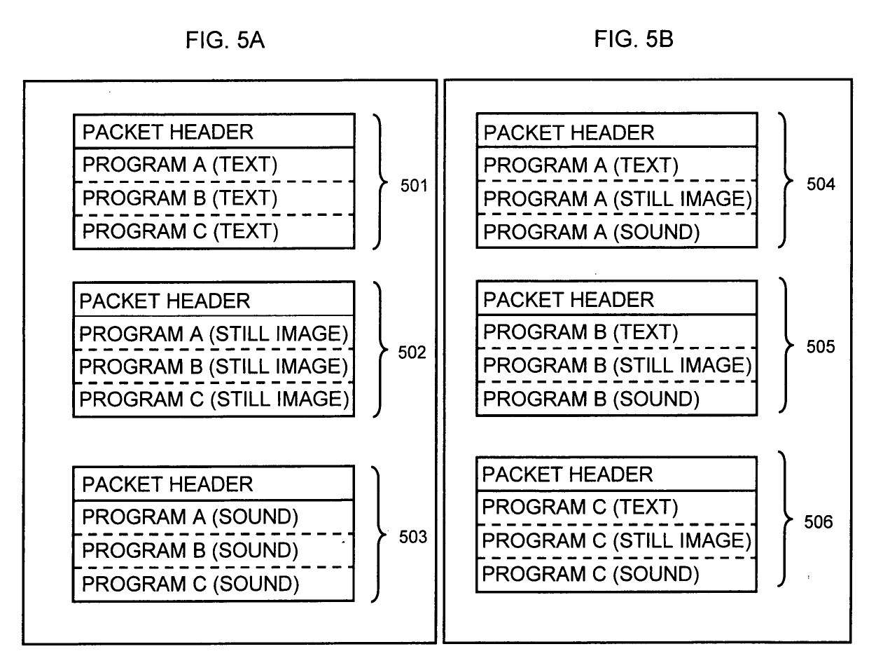

Herein, the above multiplexing methods of schemes 1 and 2 will be explained below by using FIGS. 4A, 4B, 5A and 5B. Incidentally, In FIGS. 4A, 4B, 5A and 5B, assumption is made on a case to broadcast three programs of programs A, B and C.

FIG. 4A is a flowchart showing an operation of the scheme 1, while FIG. 5A is a packet format at this time.

First, the zapping-data generating rule section 102 extracts only the text information configuring one screen of all of the zapping-data of programs A, B and C, and multiplexes them as shown in the format 501 (step S401).

Then, the still images of all of zapping-data are extracted and multiplexed as shown in the format 502 (step S402). Finally, sound information is extracted and multiplexed as shown in the format 503 (step S403).

FIG. 4B is a flowchart showing an operation of the scheme 2, while FIG. 5B is a packet format at this time.

First, the zapping-data generating rule section 102 multiplexes the information configuring the zapping-data of the program A at that time (text, still image, sound), as shown in the format 504 (step S404).

Then, the information configuring the zapping-data of the program B is multiplexed as shown in the format 505 (step S405). Finally, the information configuring the zapping-data of the program C is multiplexed as shown in the format 506 (step S406).

Incidentally, multiplication may be for a certain time width of scene-cut video, sound or animation, besides screen configuration at a certain time point. Also, besides texts, still images and sound, multiplexing may be also done for the layout information describing screen layout or display timing. Furthermore, multiplexing may be collectively all or a part of program-information. In the case of multiplexing zapping-data collectively, the reproducing process on the receiving apparatus can be made simple. Namely, made possible is the process that one of zapping-data corresponds to one of program data.

By the above process, even if the number of programs exceeds such a number that the delay between the programs is not problematic, all the programs can be transmitted evenly based on the media. Important information, if any program, can be received in a brief time by the receiving apparatus. Important information can be displayed earlier or so.

Meanwhile, in case the number of programs is within such a number that the delay between the programs is not problematic, because all of zapping-data are collectively sent based on the program, zapping-data can be transmitted efficiently to the receiving apparatus. The above multiplexing of zapping-data must not be on a media-by-media basis or based on the screen, and combination may be made in use.

Meanwhile, by strengthening error resistance through repeatingly transmitting important medias, important information can be made less liable to be missed. For example, by providing the layout information configuring program-information or screen with strong error resistance, layout information is made less liable to be missed. Accordingly, should a media in a part configuring a screen is missed, reproduction be possible without collapsing a greater screen configuration.

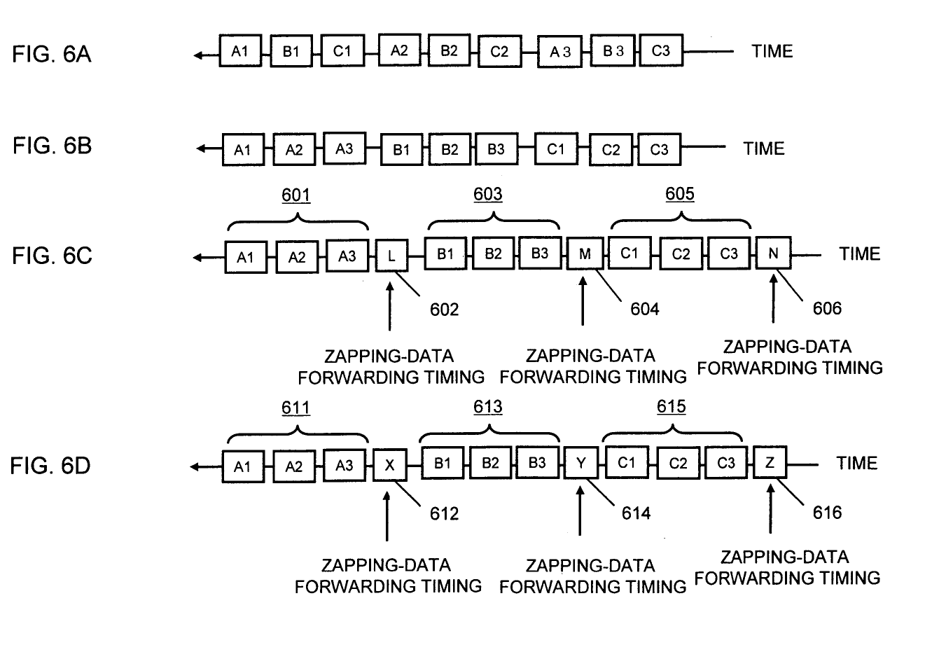

Next, FIG. 6 is a diagram showing a transmission sequence of packets to be controlled by the transmission control section 104, a constituent element of the transmitting apparatus 106.

FIG. 6A shows that the forward control section 104 cyclically transmits, packet by packet, the program data packets of programs A, B and C in the order of programs A, B and C (hereinafter, referred to as “scheme A”).

FIG. 6B shows that the forward control section 104 transmits, several (three packets in the illustrated example) in batch, the program data packets of programs A, B and C in the order of programs A, B and C (hereinafter., referred to as “scheme B”). In this case, the packet collective unit may be one-screen unit or several seconds of scene-cut unit.

The timing of forwarding zapping-data during program data transmission is shown in FIGS. 6C and 6D.

In FIG. 6C, a packet L(602) of the text data within the zapping-data of the scheme 1 shown in FIG. 5 is transmitted after transmitting the program data of one cycle 601 in the scheme A, and a packet M(604) of still image within the zapping-data is transmitted after transmitting the program data in the next cycle 603. Furthermore, after transmitting the program data in the next cycle 605, a packet N(606) of sound within the zapping-data is transmitted. This can make a display or the like of zapping-data based on the media without delay in synchronism with the program data.

In FIG. 6D, a packet X(612) of zapping-data of program C in the scheme 2 shown in FIG. 5 is transmitted after transmitting the program data of one cycle 611 in the scheme B, and a packet Y(614) of zapping-data of program A is transmitted after transmitting the program data in the next cycle 613. Furthermore, after transmitting the program data in the next cycle 615, a packet Z(616) of zapping-data of program B is transmitted. Due to this, when the receiving apparatus is under zapping, the wait time for designated channel program data or zapping-data can be made the shortest.

Incidentally, by taking into considering a transmission amount in the transmission timing of zapping-data, it may be forwarded in timing less in transmission amount before starting a program-broadcast.

Next, explanation is made below on the program-information to be prepared in the program-information generating section 112, a constituent element of the transmitting apparatus 106, by using the figures.

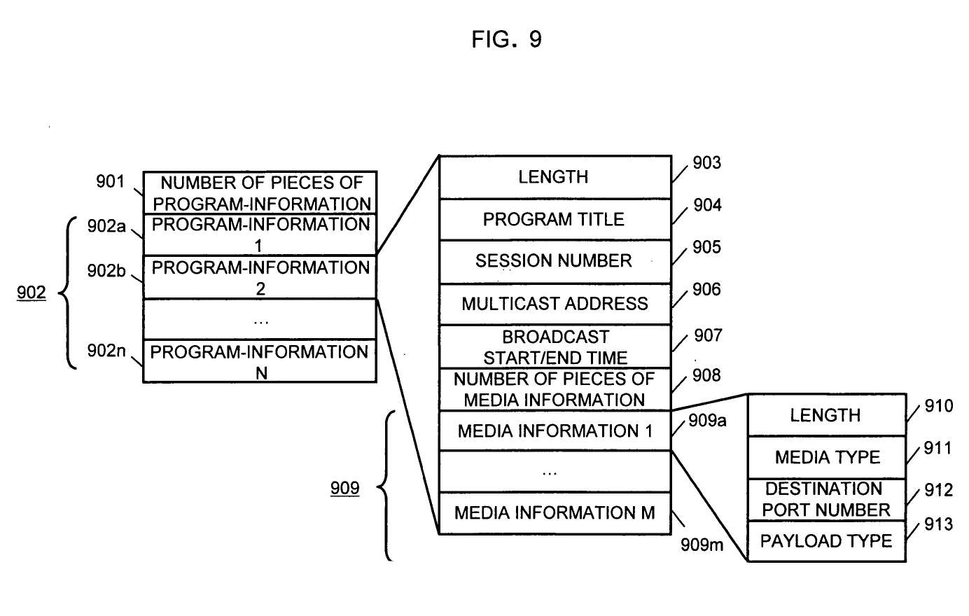

FIG. 9 is a figure showing a format of program-information.

The program-information, first, has a field of the number of pieces of program-information 901 and a field of program-information 902.

The field of the number of pieces of program-information 901 shows how many fields of program-information 902a to 902n this packet has (N in the illustrated case).

Meanwhile, the program-information 902 field comprises the fields of length 903, program title 904, session number 905, multicast address 906, broadcast start/end time 907, the number of pieces of media information 908, and media information 909.

The length 903 represents a length of the media information field. The program title 904 is a program title to be acquired from the program-information stored in the data managing section 101. Also, the session number 905 is a number specifying this program unambiguously, which is to be provided not to overlap the program-information generating section 112 with another program. The multicast address 906 represents a multicast address for sending each media. The broadcast start/end time 907 represents the time information at which the broadcast is to be started or ended. The number of pieces of media information 908 represents the number of pieces of media information 909a to 909m following this field. The media information 908 is a field describing separately various pieces of media information configuring the program data.

The media information 909 field comprises the fields of length 910, media type 911, destination port number 912 and payload type 913. The length 910 represents an overall length of the media information field (byte length). Also, the media type 911 is the field representing whether the present media data is zapping-data or program data and which media of the medias including moving image, sound, still image, text and layout information. For example, any of zapping-data and program data may be expressed by higher-order 1 bit while the remaining bits may represent any media of the medias of moving image, sound, still image, text and layout information. Meanwhile, the destination port number 912 shows to which destination port the information of media is to be sent. The receiving apparatus takes part in multicast on the basis of this destination port number 912 and multicast address 906, thereby enabling to receive the medias. Incidentally, in the case that there is difference in multicast address between the medias, a multicast address 906 is to be inputted to the media information field 909 instead of the program-information field 902. The payload type 913 is a payload type to be stored in a header part of each of media data. This is required for distinguish between the medias in the case a plurality of medias are sent to the same multicast address and destination port number. In the case that there is a premise to send the medias to different destination ports, that is an unnecessary field.

Although the above is the format of program-information, it is possible to apply every format capable of transmitting program-information without limited to that format form.

Next, the operation and function of the receiving apparatus 111 will be explained below.

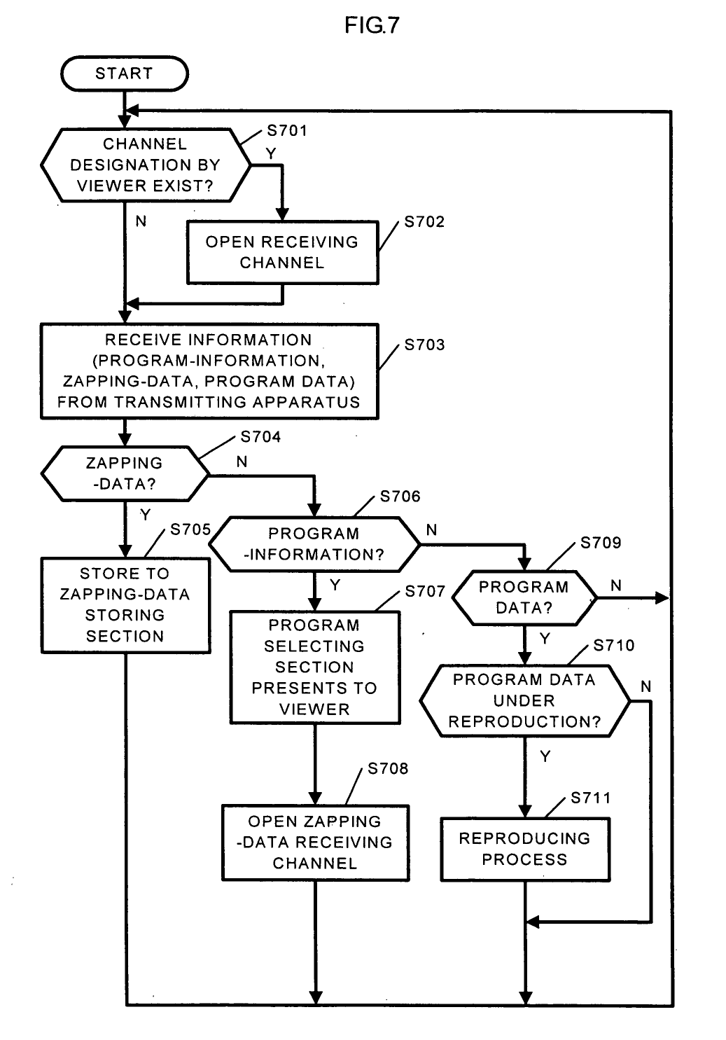

FIG. 7 is a flowchart explaining a data receiving process to be made by the receiving apparatus in embodiment 1 of the invention.

First, the program selecting section 117 checks whether there is a program channel designation from a viewer or not (step S701). In the case there is no designation, movement is to step S703.

In the case there is a program channel designation from a viewer, the program selecting section 117 notifies a receiving channel to the transmitting section 115, and thereafter the transmitting section 115 opens the receiving channel (step S702) to receive the information (zapping-data, proram information, program data) sent from the transmitting apparatus 106 (step S703).

Next, zapping-data, program-information and program data are classified in the reception control section 107. If the received data is zapping-data (step S704), the reception control section 107 delivers the data to the zapping-data restoring section 110 and the zapping-data storing section 109 stores it (step S705).

In the case the received data is program-information (step S706), the reception control section 107 delivers the data to the program selecting section 117. The program selecting section 117 presents the viewer a list of the programs currently on the air (step S707). Also, the program selecting section 117 acquires all zapping-data reception channels currently on the air from the received program-information and notifies the reception channel to the transmitting section 115. Thereafter, the transmitting section 115 opens the notified channel to start a zapping-data reception (step S708), then returning to step S701.

Meanwhile, in the case the received data is program data (step S709) which has been reproduction-processed (step S710), the reception control section 107 delivers the data to the reproduction control section 108. The reproduction control section 108 reproduction-processes the program data (step S711), thereafter returning is to step S701.

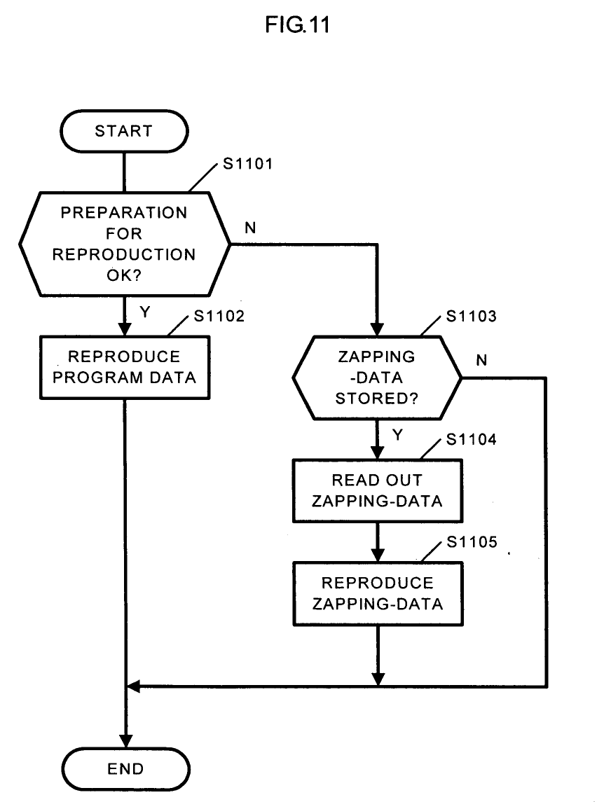

Next, the above program reproducing process (step S711) will be explained by using FIG. 11.

This process is to be executed when the viewer selects a program on the program selecting section 117.

First, the reproduction control section 108 checks with the received program data whether preparation for reproduction has been done or not (step S1101). In the case that preparation for reproduction has been done, the reproduction control section 108 reproduces the program data (step S1102).

In the case that preparation for reproduction has not been done, the reproduction control section 108 notifies a zapping-data acquisition request to the zapping-data restoring section 110. The zapping-data restoring section 110 receives this and determines whether there is zapping-data in the zapping-data storing section 109 or not (step S1103). In the case there is zapping-data, the zapping-data restoring section 110 reads zapping-data from the zapping-data storing section 109 and delivers it to the reproduction control section 108 (step S1104). The reproduction control section 108 receives the zapping-data and carries out a reproduction process to make a reproduction on the display section 116 (step S1105).

On the other hand, in the case there is no zapping-data in the zapping-data storing section 109, the program reproducing process is ended, returning to the first step S701. Herein, preparation for reproduction done represents a state having ended a minimally required process in starting a program reproduction. For example, it represents a state that the decoder for each of data has prepared for data acceptance to receive layout information wherein at least one of the medias to be reproduced (moving image, sound, still image, text) is in a reproducible state. The state the media is reproducible, for video or audio stream data, is a state that pre-buffering has been completed, and, for download data such as still image and text, represents a state that all of data configuring the media has been received.

By the above operation, when the viewer switches a program to be received, if the receiving terminal unit is stored with zapping-data, it can be presented soon to the viewer. Due to this, the viewer can know the outline or the like of a program to be viewed without waiting for a lapse of reproduction waiting time after switching the program to be received, realizing high-speed zapping.

Also, in the selection of zapping-data to be reproduced, it is possible to select data having no direct bearing on the program such as advertisement or announcement without limited to the zapping-data for program data being received.

In this case, even if a preparation for reproduction has been done in step S1101, switching can be after reproducing the zapping-data without immediately switching to program data reproduction by the reproduction control section 108.

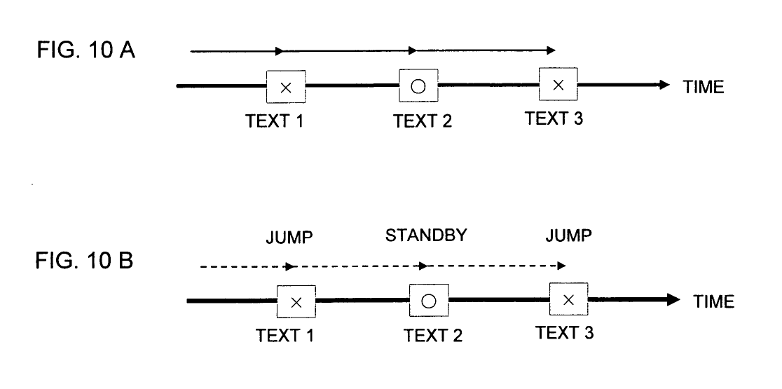

FIGS. 10A and 10B are diagrams explaining a reproducing method in the case impossible to receive the program data capable of configuring one screen. Using this figure, explanation is made for a time point when a preparation for reproduction is concretely done. It is a figure explaining a case that one-screen program data is configured with a plurality of ones of data wherein the data on display is different in time. In the illustrated example, there is shown an example that three texts of text 1-text 3 are to be sequentially displayed on time. In the illustrated example, “0” shows a case that data has been correctly received while “x” shows that data has not been correctly received. In the illustrated example, only the text 2 is correctly received but the texts 1 and 3 are not correctly received.

There can be considered two as reproducing methods for the case the data is not correctly received. The first method is a method, as shown in FIG. 10A, that a data reproducing process is started at a reproducing time regardless of whether data could have been received or not, wherein, if data has not been correctly received, data reproduction is skipped. Herein, skipping means to reproduce another of media data instead of displaying the relevant media data. In such a method, at a start of data reproduction, data minimally is available wherein reproduction is commenced if there are reproducible ones. Accordingly, in the case such a reproducing method is employed, the time point the preparation for reproduction is done is at a time that the decoder for each of data is prepared for data acceptance to receive layout information wherein at least one of the medias to be reproduced (moving image, sound, still image, text) is placed in a reproducible state. The state the media is reproducible, for video or audio stream data, is a state that pre-buffering has been completed, and, for download data such as still image and text, represents a state all of data configuring the media has been received. The second method is a method, as shown in FIG. 10B, that jumping is made to a text corresponding to a reproducing time wherein, where there exists no text process fallen on the reproducing time, the process is suspended (standby) to the time that a subject of process becomes existing. Namely, it is the scheme that, where there is no, even one, media data at a reproducing time, reproducing is not done at all. In the case of reproducing by such a method, when the program to be reproduced is switched, reproducing is commenced when all of media data becomes available. Accordingly, in the case such a reproducing method is employed, the time point the preparation for reproduction is done is at a time point that the decoder for each of data is prepared for data acceptance to receive layout information wherein all of the medias to be reproduced (moving image, sound, still image, text) are placed in a reproducible state. The subject of media may use a media such as moving image, still image or sound, without being necessarily limited to text. For reproducing time and display position, expression may be by using SMIL, for example.

Second Exemplary Embodiment

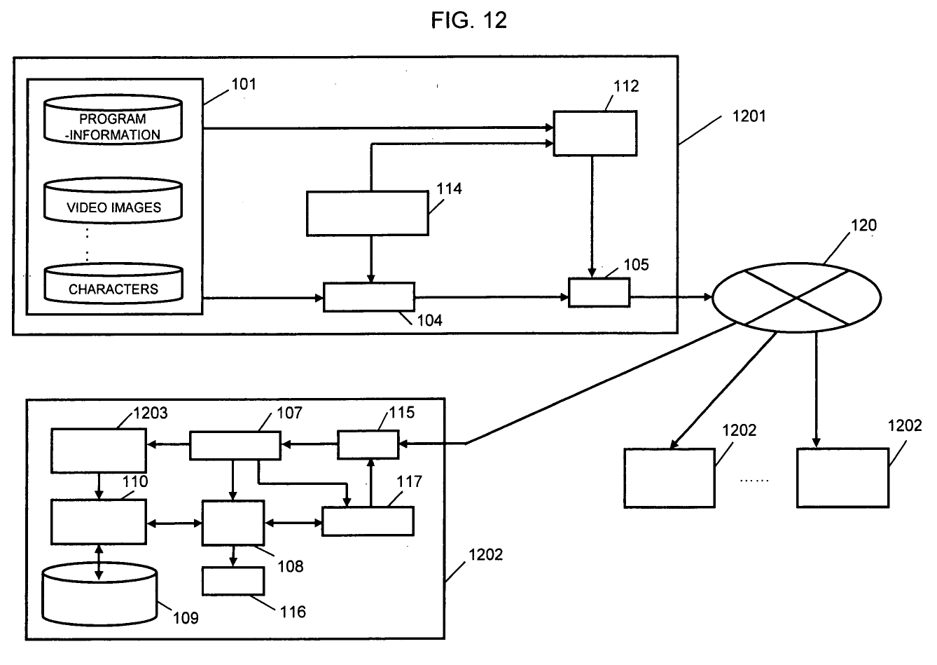

FIG. 12 is a block diagram of an information browser system in embodiment 2 of the invention.

The difference from the information browser system in the first lies in that the constituent elements of the transmitting apparatus 106, i.e. the zapping-data generating rule section 102, the zapping-data selecting section 103 and the zapping-data multiplexing section 113, are not provided in the transmitting apparatus 1201 of this embodiment and in that the data managing section 101 of the transmitting apparatus 1201 does not possess zapping-data. Also, there is a difference in that a zapping-data generating section 1203 is added to the receiving apparatus 1202 of this embodiment.

This zapping-data generating section 1203 receives program data from the reception control section 107 and selects the one to be utilized as zapping-data from that, to generate zapping-data and deliver it to the zapping-data restoring section 110. The criterion of zapping-data selection can be layout information less in data amount, similarly to the zapping-data selecting section 103 in FIG. 1, text or still image only, among program-information, or program title or program representative screen among video data. Otherwise, this may be provided by a part of video or audio data, such as the recent I frames or several seconds of sound data among the data currently broadcast.

Meanwhile, the zapping-data to be generated can be previously prepared in plurality of kinds different in reproduction time, e.g. for 3 seconds or for 5 seconds. This makes it possible to anticipate a switching time to the program data during zapping and to reproduce zapping-data in accordance with the anticipation time.

Furthermore, it is effective to display this anticipation time on part of the screen. Incidentally, because the anticipation for switching time, in a streaming using RTP/UDP, can be set equal to buffering time, previously prepared is zapping-data in an amount for buffering time.

Concerning the transmitting apparatus 1201 and receiving apparatus 1202 configured as in the above, the operation and function will be explained below.

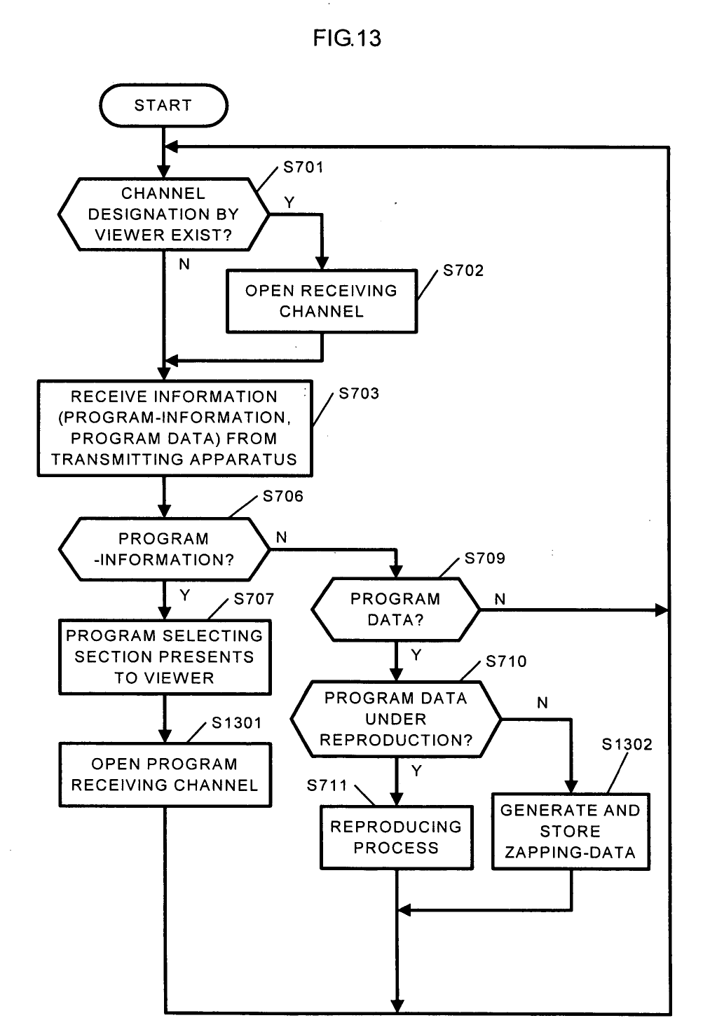

FIG. 13 is a flowchart showing the operation of the receiving apparatus in the second one.

The transmitting apparatus 1201 distribute only program-information and program data to the receiving apparatus 1202 by the scheme A shown in FIG. 6A or the scheme B shown in FIG. 6B, without transmitting zapping-data as per the above.

The receiving apparatus 1202, in the case that a program channel is designated from a viewer (step S701), opens the program channel a program to be reproduced has been designated (step S702). At this time, concerning the media whose channel has already opened in step S1301, there is no need to open the channel.

Next, the transmitting section 115 receives the information (program-information, program data) sent from the transmitting apparatus 106 (step S703).

Next, the reception control section 107 checks whether the received data is program-information or not (step S706). In the case of program-information, the program-reception control section 107 delivers the data to the program selecting section 117 similarly to the first, and the program selecting section 117 presents a list of the programs currently on the air to the viewer (step S707). Also, the program selecting section 117 acquires the reception channels for all the programs currently on the air from the received program-information, and notifies the reception channels to the transmitting section 115. The transmitting section 115 opens the notified channel to commence for receiving program data (step S1301). At this time, there is no need of opening the channel for the media data not stored as zapping-data.

In the case that the received data is not program-information, the reception control section 107 checks whether the received data as been program data or not (step S709). In the case of not program data, returning is to step S701.

In the case that the received data is the program data under reproduction selected by the viewer (step S710), the reception control section 107 delivers the program data to the reproduction control section 108 and carries out the same reproducing process as the first (step S711). Thereafter, returning is to step S701.

On the other hand, in the case that the received data is not the program data under reproduction-, the reception control section 107 delivers the program data to the zapping-data generating section 1203. The zapping-data generating section 1203 extracts required data from the program data and generates zapping-data. Then, the generated zapping-data is delivered to the zapping-data restoring section 110 and stored in the zapping-data storing section 109 (step S1302). Thereafter, returning is to step S701. Herein, the storage process of zapping-data is always updated each time of a predetermined data amount, being in the recent zapping-data. The predetermined data amount means a data amount sufficient for the time up to providing the necessary data for reproduction when the program is switched with zapping. As in the above, in the receiving apparatus 1202 of this embodiment, because the channel is always opened to store, as zapping-data, a part of program data of all the programs currently on the air, when the viewer carries out zapping, zapping-data can be presented soon. Due to this, even in case zapping-data is not distributed from the transmitting apparatus 1201, the viewer can view the video image or the like immediately preceding the program to be desirably viewed before elapsing a reproduction wait time after switching the viewing program, thus realizing high-speed zapping.

Meanwhile, by previously storing as zapping-data the layout information only among the program data and taking out the stored layout information when the program is selected, the reception wait time of layout information is shortened, enabling to shorten the total reproduction wait time.

Third Exemplary Embodiment

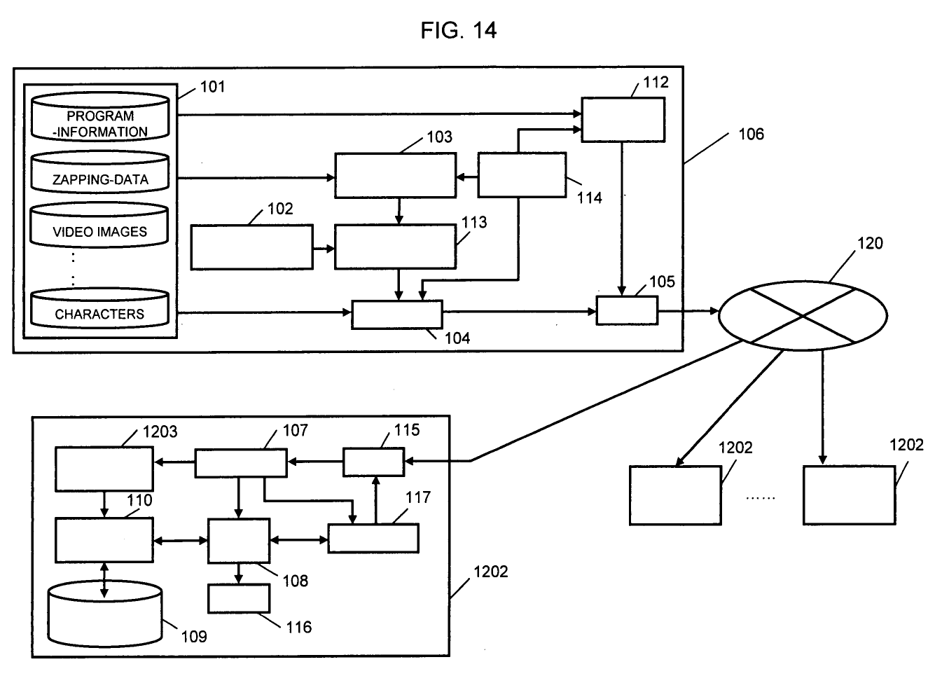

FIG. 14 is a block diagram of an information browser system in embodiment 3 of the invention.

This system is structured with the transmission apparatus 106 in embodiment 1, the receiving apparatus 1202 in embodiment 2 and an IP network 120.

Concerning the receiving apparatus 1202 in the information browser system configured as in the above, the operation and function will be explained below.

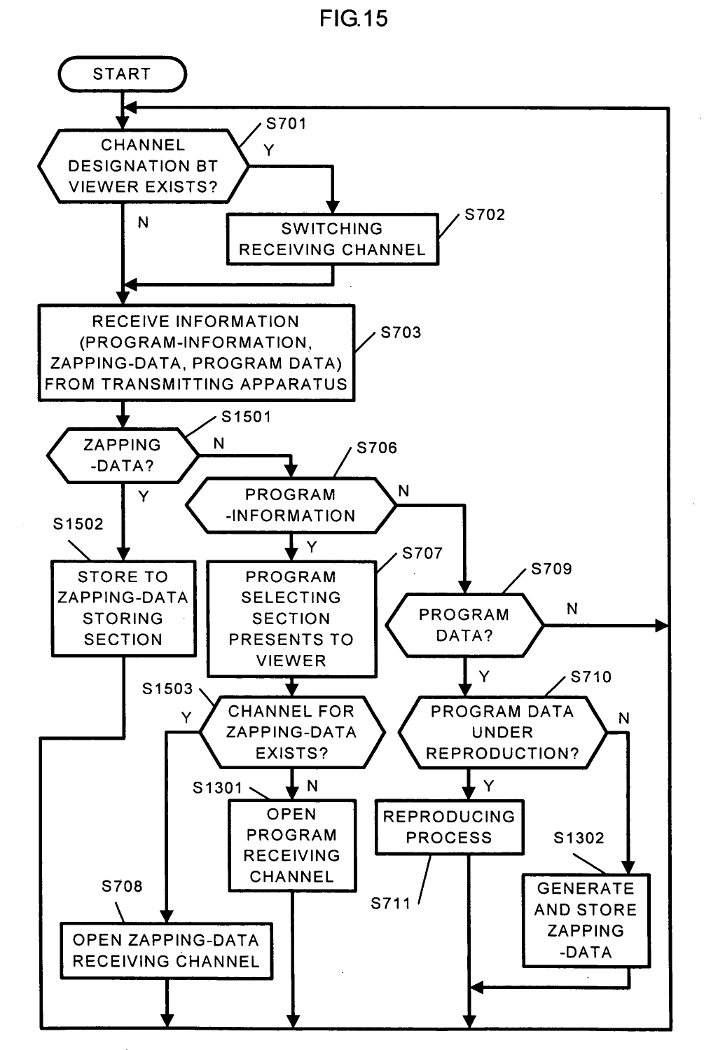

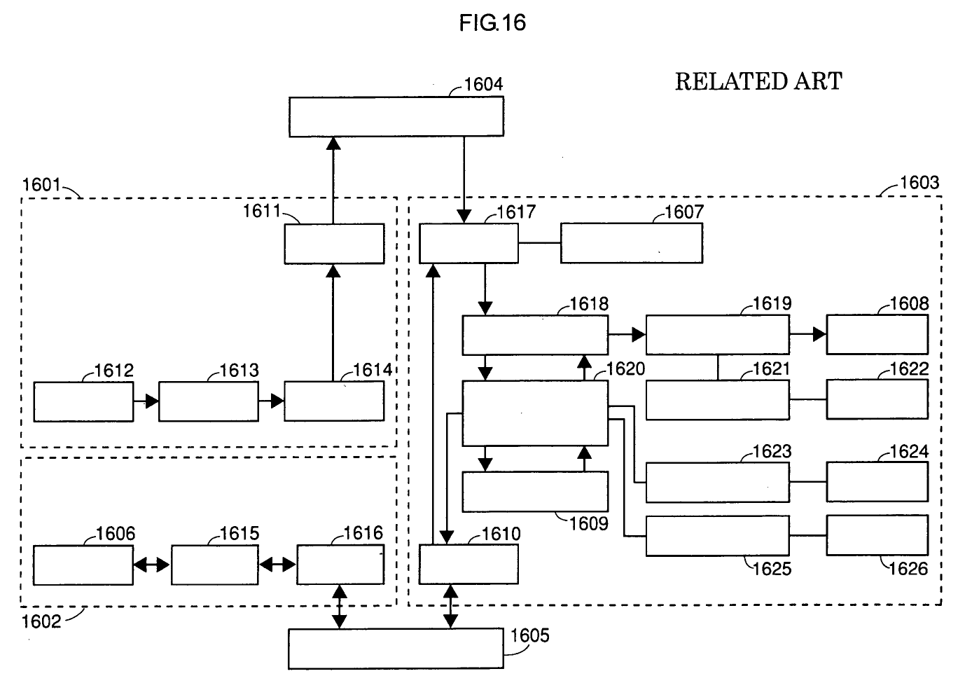

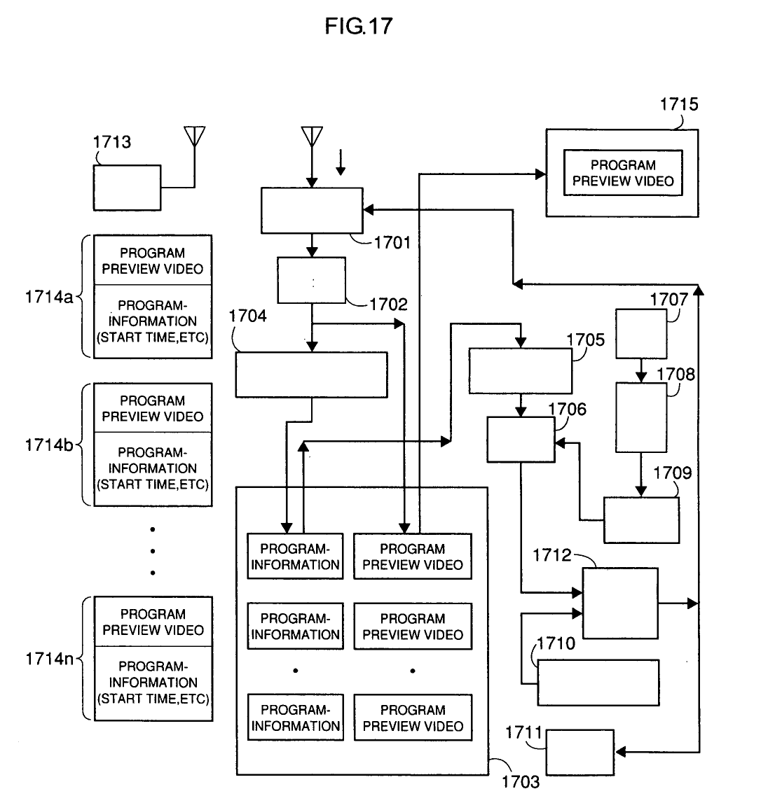

FIG. 15 is a flowchart explaining the operation of the receiving apparatus 1202. The difference, from the operation of receiving apparatus 1202 shown in FIG. 13 in embodiment 2, lies in the below points.

Namely, the reception control unit 107 checks whether the received data is zapping-data or not (step S1501). In the case of zapping-data, the reception control section 107 delivers the data to the zapping-data restoring section 110 and the zapping-data storing section 109 stores it (step S1502).

Also, when receiving program-information, it is examined whether there is a description of a channel for zapping-data in the program-information or not. In the case there is a channel for zapping-data (step S1503), the channel is opened (step S708). If there is no channel for zapping-data, opened is the reception channel for program data (step S1301).

Thereafter, returning is to step S701.

The other than the above process is the same as the receiving apparatus 1202 in embodiment 2.

By the above operation, the receiving apparatus 1202 stores zapping-data for the program whose zapping-data has been sent, and generates and stores zapping-data from the program data for the program whose zapping-data has not been sent, whereby the viewer always can view the video image or the like by switching the program to be received at, high speed upon zapping.

Also, in also the case that zapping-data is sent by the scheme D shown in FIG. 6D, the both are stored of the sent zapping-data and the zapping-data generated from the packet in a part of the program data, whereby zapping-data can be previously stored more swiftly for all the channels. Specifically, in FIG. 6D, by leaving a part of the program data of program A (e.g. packet Al), it can be utilized as zapping-data. In case a packet X612 is sent as zapping-data, the zapping-data of program C can be immediately utilized. Because a packet Bi is sent soon after the packet X612, it is possible to immediately prepare the zapping-data of programs A to C.

Due to this, even if the viewer commences zapping at any timing, it is always possible to display or so, in the most brief time, the outline of a program on the air or broadcast scene immediately before.

### INDUSTRIAL APPLICABILITY

As in the above, the present invention is useful for the program-broadcast using an IP network with packet transmission, which is suited for the viewer to carry out zapping through channels at high speed.

1. A method of browsing information in a broadcast using packet transmission comprising:
a step of receiving program data and zapping-data as data for realizing zapping;
a step of storing the zapping-data; and
a step of reproducing the zapping-data until a layout information in program data selected upon program reproduction is received and at least one of medias reproduced becomes reproducible.

2. A method of browsing information according to claim 1, wherein the zapping-data is at least any one of a part of a program including layout information, a digest, a representative screen, a program title (text), a preview, an announcement and an advertisement.

3. A method of browsing information according to claim 2, wherein information of the zapping-data is multiplexed based on a media kind or information configuring a screen.

4. A method of browsing information according to claim 1, further comprising a step of generating the zapping-data from the program data received.

5. A transmitting apparatus in a broadcast using packet transmission comprising:
a program-broadcast managing section for controlling a start and end of a program-broadcast;
a data managing section for storing data to be sent;
a zapping-data selecting section for generating or selecting zapping-data as data for realizing zapping from the data stored in the data managing section, on the basis of an instruction from the program-broadcast managing section;
a forward control section for forwarding, on a predetermined rule, program data from the data managing section and the zapping-data from the zapping-data selecting section; and
a transmitting section for receiving data from the forward control section and packet-transmitting the zapping-data and the program data.

6. A transmitting apparatus according to claim 5, further comprising:
a zapping-data generating rule section for determining a multiplexing scheme of zapping-data; and
a zapping-data multiplexing section for multiplexing zapping-data by a multiplexing scheme determined in the zapping-data generating rule section.

7. A transmitting apparatus according to claim 6, wherein the multiplexing scheme is for multiplexing based on a program in a case that the number of programs to be simultaneously sent is within a predetermined number and for multiplexing based on any of a media kind and information configuring a screen in a case of equal to or greater than the predetermined number.

8. A transmitting apparatus according to claim 6, wherein zapping-data is sent before starting a program-broadcast as a subject of the zapping.

9. A receiving apparatus in a broadcast using packet transmission comprising:
a transmitting section for receiving packet-transmitted zapping-data as data for realizing zapping and program data;
a reception control section for discriminating a kind of information received by the transmitting section;
a zapping-data storing section for storing the zapping-data discriminated;
a program selecting section for instructing to receive the program data a viewer has selected;
a reproduction control section for reproducing zapping-data concerning the program data taken out of the zapping-data storing section until the transmitting section receives a layout information due to the instruction and at least one of medias reproduced becomes reproducible; and
a zapping-data restoring section for selecting and taking out the zapping-data instructed for taking out from the reproduction control section.

10. A receiving apparatus according to claim 9, further comprising a zapping-data generating section for generating the zapping-data from received program data.

11. A receiving apparatus in a broadcast using packet transmission comprising:
a transmitting section for receiving program data;
a zapping-data generating section for generating zapping-data as data for realizing zapping from the program data received;
a zapping-data storing section for storing the zapping-data;
a program selecting section for instructing to receive the program data a viewer has selected;
a reproduction control section for reproducing zapping-data concerning the program data taken out of the zapping-data storing section until the reception data received due to the instruction by the transmitting section becomes reproducible; and
a zapping-data restoring section for selecting and taking out the zapping-data instructed for taking out from the reproduction control section.
